(19) United States
(12) Patent Application Publication
(10) Pub. No.: US 2012/0094007 A1
(43) Pub. Date: Apr. 19, 2012

(54) METHOD FOR THE IMMOBILIZATION OF CATIONIC ACTIVE INGREDIENTS ON SURFACES

(75) Inventors: Marcus Fehr, Speyer (DE); Ulf Baus, Dossenheim (DE); Thomas Subkowski, Schriesheim (DE); Catharina Hippius, Mannheim (DE)

(73) Assignee: BASF SE, Ludwigshafen (DE)

(21) Appl. No.: 13/272,571

(22) Filed: Oct. 13, 2011

Related U.S. Application Data
(60) Provisional application No. 61/392,501, filed on Oct. 13, 2010.

(51) Int. Cl. B05D 3/00; C09D 5/14

(52) U.S. Cl. 427/2.14; 523/122

(57) ABSTRACT

A method and composition for immobilizing an antimicrobial active ingredient on a surface of a substrate, in which the surface of the substrate is treated with a composition comprising
(i) a solvent,
(ii) a hydrophobin,
(iii) a cationic antimicrobial active ingredient,
(iv) optionally additives or auxiliary components,
   which permits a long-lasting antimicrobial finishing of the substrate surface.

### RELATED APPLICATIONS

This application claims benefit of U.S. provisional application 61/392,501, filed Oct. 13, 2010, which herein is incorporated by reference in its entirety.

### SEQUENCE LISTING

The Sequence Listing associated with this application is filed in electronic format via EFS-Web and is incorporated by reference into the specification. The name of the text file containing the Sequence Listing is SEQUENCE_LISTING_{—}13156-00443-US_ST25.txt. The size of the text file is 73 KB, and the text file was created on Oct. 13, 2011.

### BACKGROUND OF THE INVENTION

Antimicrobial finishing of surfaces and the application of antimicrobial active ingredients to various substrates (“depositioning”) are of great practical importance for a variety of technical applications. In medical technology and in many sectors of domestic and clinical hygiene, the long-lasting avoidance of a bacteria colonization plays a decisive role.

One aim when applying antimicrobial active ingredients is to immobilize one or more active ingredients which reduce the ability of the microorganisms to multiply and/or the infectiosity of microorganisms on the surface of substrates and/or articles in such a way that the active ingredients during use are not washed off from the surface in an uncontrolled manner and thus the protection is lost. Since different surfaces are treated quite differently, for example are washed or subjected to weathering, various immobilization techniques are used. These methods often also bring about a deactivation of the antimicrobial active ingredients or they do not bind the antimicrobial active ingredients tight enough to the surfaces, meaning that the active ingredients are washed off too rapidly and the surfaces lose their antimicrobial properties.

As early as 2006, the adsorption of the antimicrobial active ingredient polyhexamethylenebiguanide onto cellulose substrates was described. The active ingredient was applied to hydrophilic, anionic surfaces (see R. Blackburn et al., Langmuir 2006, 22, 5636-5644, “Sorption of Poly-(hexamethylenebiguanide) on Cellulose”). The binding of the active ingredient takes place here via hydrogen bridges and ionic interactions.

The covalent immobilization of cationic antimicrobial active ingredients such as, e.g., antimicrobial peptides requires model surfaces with functional groups or the introduction of a functional group on inert polymer surfaces (such as, e.g., silicone and PVC) (see S. Haynie et al., Antimicrobial Agents and Chemotherapy, 02-1995, 301-307; V. Humblot et al., Biomaterials 30, 2009, 3503-3512).

Furthermore, the functional groups or the antimicrobial active ingredients to be immobilized must be activated in order to link covalent bonds. The introduction of functional groups and the activation, however, are additional steps associated with technical complexity and costs. Furthermore, the effect of the antimicrobial active ingredients is considerably reduced by the covalent immobilization, meaning that the surfaces finished in this way are not permanently able to effectively prevent colonization by bacteria (see V. Humblot 2009; Bagheri et al., Antimicrobial Agents and Chemotherapy, 03-2009, 1132-1141).

A technical alternative to the covalent immobilization of cationic active ingredients is adsorption with the help of polyelectrolyte layers. Here, the cationic active ingredient can itself be a polyelectrolyte (see US2007/0243237) or the cationic active ingredient can be embedded into a polyelectrolyte layer (see US2009/0258045).

### DESCRIPTION OF RELATED ART

US2007/0243237 describes a method for applying an antimicrobial coating, in which a negatively charged polyelectrolyte component and also a positively charged polyelectrolyte component are applied as film to a substrate, where at least one of the components has an antimicrobial activity. For example, a known biocidal component can be covalently bonded to a charged polymer. US 2009/0258045 describes a coated structure which is coated firstly with a charged, antimicrobial peptide and secondly with a polyelectrolyte component. As a result of a two-ply coating, a preservation of the substrate can be achieved. One advantage of this approach is that it is possible to dispense with an activation which is necessary for closing a covalent bond. However, in the case of inert polymer surfaces (e.g. silicone and PVC), it is often necessary, prior to the adsorption of the first polyelectrolyte layer, to apply anionic charges to the surface to be coated (see US 2002/0146385). One aim of this treatment is a better adhesion of the polyelectrolytes. Furthermore, it is often necessary to apply two or more layers of anionic and cationic polyelectrolytes to the surface to be coated (see US 2007/0243237). All of these additional steps are associated with high complexity and costs.

Further prior art problems are the deactivation of the cationic antimicrobial active ingredients as a result of charge compensation with anionic polyelectrolytes and unfavorable release kinetics (see O. Etienne et al., Antimicrobial Agents and Chemotherapy, 10-2004, 3662-3669). Both often lead to a reduced or shortened antimicrobial effect (see also US 2009/0258045).

The immobilization of active ingredients by proteins such as hydrophobin is also known per se. For example WO 2004/000880 describes the binding of enzymes to surfaces treated with hydrophobin. Hydrophobins are known as small, cysteine-rich proteins, which occur, e.g. in filamentous fungi such as Schizophyllum commune. Naturally occurring hydrophobins have often about 100 to 150 amino acids. They generally have eight cysteine units in the molecule. Hydrophobins can be isolated from natural sources, but they can also be obtained by means of genetic engineering methods, as disclosed, for example, in WO 2006/082251 or WO 2006/131564.

The surface-active and the emulsifying effect of hydrophobins and also a variety of applications for hydrophobins have been described. WO 1996/41882 proposes the use of hydrophobins as emulsifiers, thickeners, surface-active substances, for the hydrophilization of hydrophobic surfaces, for improving the water resistance of hydrophilic substrates, for producing oil-in-water emulsions or water-in-oil emulsions. Furthermore, pharmaceutical applications such as the production of ointments or creams and also cosmetic applications such as skin protection or the manufacture of hair shampoos or hair rinses are proposed. WO 2006/082253 discloses formulations for the coating of surfaces, e.g. of finely-divided inorganic or organic particles, with hydrophobins. For this, the aqueous hydrophobin solutions are applied to the surface to be coated.

WO 2006/103215 discloses the use of hydrophobins for the soil-repelling treatment of hard surfaces, such as, for example, floors. WO 2006/103230 discloses the use of aqueous formulations of hydrophobins for the surface treatment of hardened mineral building materials.

WO 2004/000880 describes the non-covalent binding of antibodies, enzymes, peptides, lipids, nucleic acids and carbohydrates to surfaces treated with hydrophobin.

U.S. Pat. No. 7,393,448 describes the non-covalent inclusion of substances which are even smaller than the protein hydrophobin, into a hydrophobin coating on a sensor surface.

WO 2000/40968 describes a method for producing immuno-absorbing materials with bonding of antibodies to a surface through use of hydrophobin.

### BRIEF SUMMARY OF THE INVENTION

An object of the present invention is to develop as simple a method as possible for immobilizing one or more antimicrobial active ingredients which can be used for a variety of active ingredients and various surfaces. The method using the cysteine-rich protein hydrophobin should also not lead to the deactivation of the antimicrobial effect. In particular, cationic antimicrobial active ingredients (e.g., the antiseptic polyhexamethylenebiguanide) have a very good antimicrobial effect and are used in many areas of application. An immobilization method on surfaces is therefore of particular interest for the class of substances of the cationic antimicrobial active ingredients.

### BRIEF DESCRIPTION OF THE DRAWINGS

FIG. 1 shows diagrammatically the effect of the antimicrobial finishing on the colonization of the surface of a substrate by microorganisms.

FIG. 2 shows the anti-biofilm activity of silicon surfaces following adsorption of the active ingredient polyhexamethylenebiguanide (Reputex 20). FIG. 2A shows the number of bacteria under various washing conditions.

FIG. 3 shows the anti-biofilm activity of silicone surfaces following adsorption of Reputex 20 with the help of hydrophobin A.

FIG. 4 shows the anti-biofilm activity of silicone surfaces following adsorption of the active ingredient component PEI-P18 conjugate.

FIG. 5 shows the anti-biofilm activity of silicone surfaces following adsorption of the active ingredient component PEI-P18 conjugate with the help of hydrophobin.

FIG. 6 shows the anti-biofilm activity of silicone surfaces against E. coli following adsorption and covalent bonding of the antimicrobial peptide P18 with the help of hydrophobin A.

FIG. 7 shows the anti-biofilm activity of silicone surfaces against S. epidermidis following adsorption of polyhexamethylenebiguanide (Reputex 20) with the help of hydrophobin B.

FIG. 8 shows the anti-biofilm activity of silicone surfaces against S. epidermidis following adsorption of Reputex 20 with the help of hydrophobin B.

### DETAILED DESCRIPTION OF THE INVENTION

Within the context of the present invention, the term “hydrophobins” (H) is to be understood as meaning hereinbelow in particular polypeptides of the general structural formula (I)

Xₙ—C¹—X₁₋₅₀—C²—X₀₋₅—C³—X₁₋₁₀₀—C⁴—X₁₋₁₀₀—C⁵—X₁₋₅₀—C⁶—X₀₋₅—C⁷—X₁₋₅₀—C⁸—Xₘ (I)

wherein each X independently denotes an amino acid sequence consisting of amino acids selected from the 20 naturally occurring amino acids (Phe, Leu, Ser, Tyr, Cys, Trp, Pro, His, Gln, Arg, Ile Met, Thr, Asn, Lys, Val, Ala, Asp, Glu, Gly) and wherein each X can be identical or different. The numbers adjacent X indicate the range of numbers of amino acid residues comprising each amino acid sequence X, and each amino acid residue within each X independently may be identical or different.

C is cysteine, alanine, serine, glycine, methionine or threonine, where at least four of the radicals designated C are cysteine. The indices n and m, independently, are natural numbers between 0 and 500, preferably between 15 and 300, indicating the number of amino acid residues comprising the adjacent X.

The polypeptides according to formula (I) are also characterized by the property that, at room temperature, they bring about, following coating of a glass surface with the polypeptide, an increase in the contact angle of a water drop on the glass surface of at least 20°, preferably at least 25° and particularly preferably 30°, in each case compared with the contact angle of an identically sized water drop on an uncoated glass surface. The amino acids designated C¹ to C⁸ are preferably cysteines. However, they may also be replaced by other amino acids of similar spatial arrangement, preferably by alanine, serine, threonine, methionine or glycine. However, at least four, preferably at least 5, particularly preferably at least 6 and in particular at least 7, of the positions C¹ to C⁸ should consist of cysteines. Cysteines may be present in the proteins according to the invention either in reduced form, or form disulfide bridges with one another. Particular preference is given to the intramolecular formation of C—C bridges, in particular those with at least one, preferably 2, particularly preferably 3 and very particularly preferably 4, intramolecular disulfide bridges.

In the case of the above-described exchange of cysteines for amino acids of similar spatial filling, both C-positions are advantageously exchanged in pairs which can form intramolecular disulfide bridges with one another.

If cysteines, serines, alanines, glycines, methionines or threonines are also used in the positions referred to as X, numbering in the individual C positions in the general formulae can change accordingly.

Preference is given to hydrophobins of general formula (II)

Xₙ—C¹—X₃₋₂₅—C²—X⁰⁻²—C³—X₅₋₅₀—C⁴—X₂₋₃₅—C⁵—X₂₋₁₅—C⁶—X₀₋₂—C⁷—X₃₋₃₅—C⁸—Xₘ (II)

for carrying out the present invention, where X, C and the indices alongside X and C have the meaning in formula (I) above, the indices n and m are numbers between 0 and 350, preferably 15 to 300, the proteins are further characterized by the aforementioned contact angle change of a water drop, and furthermore at least 6 of the radicals designated C are cysteine. It is particularly preferred that all of the radicals C are cysteine. Preference is also given to using hydrophobins of the general formula (III)

Xₙ—C¹—X₅₋₉—C²—C³—X₁₁₋₃₉—C⁴—X₂₋₂₃—C⁵—X₅₋₉—C⁶—C⁷—X₆₋₁₈—C⁸—Xₘ (III)

where X, C and the indices alongside X have the above meaning in formula (I) above, the indices n and m are numbers between 0 and 200, the proteins are further characterized by the aforementioned contact angle change of a water drop, and at least 6 of the radicals designated C are cysteine. It is particularly preferred that all of the radicals C are cysteine. the radicals Xₙ and Xₘ may be peptide sequences which are naturally also linked to a hydrophobin. However, it is also possible for one or both radicals to be peptide sequences which are naturally not linked to a hydrophobin. These are also understood as meaning those radicals Xₙ and/or Xₘ in which a peptide sequence which occurs naturally in a hydrophobin is extended by a peptide sequence which does not occur naturally in a hydrophobin.

If Xₙ and/or Xₘ are peptide sequences which are naturally not linked to hydrophobins, such sequences are generally at least 20, preferably at least 35, amino acids in length. They may be, for example, sequences made of 20 to 500, preferably 30 to 400 and particularly preferably 35 to 100 amino acids. Such a radical which is naturally not linked to a hydrophobin will also be referred to below as fusion partner.

This expression is intended to mean that the proteins can consist of at least one hydrophobin part and one fusion partner part which do not occur together in this form in nature.

Fusion hydrophobins made of fusion partner and hydrophobin parts are described, for example, in WO 2006/082251, WO 2006/082253 and WO 2006/131564, each of which is herein incorporated by reference in its entirety.

The fusion partner part can be selected from a large number of proteins. It is possible for just a single fusion partner to be linked to the hydrophobin part, or it is also possible for a plurality of fusion partners to be linked to a hydrophobin part, for example on the amino terminus (Xₙ) and on the carboxy terminus (Xₘ) of the hydrophobin part. However, it is also possible, for example, for two fusion partners to be linked to one position (Xₙ or Xₘ) of the protein according to the invention. Particularly suitable fusion partners are proteins which occur naturally in microorganisms, in particular in Escherichia coli or Bacillus subtilis. Examples of such fusion partners are the sequences yaad (SEQ ID NO: 16), yaae (SEQ ID NO:18), ubiquitin and thioredoxin. Also highly suitable are fragments or derivatives of these specified sequences, which comprise only part, for example, 70 to 99%, preferably 5 to 50%, and particularly preferably 10 to 40%, of the specified sequences, or in which individual amino acids, or nucleotides have been altered compared with the specified sequence, the percentages given in each case referring to the number of amino acids. The assignment of the sequence names to DNA and polypeptide sequence and the corresponding sequence protocols can be found in the application WO 2006/103225 (p. 13 of the description and sequence protocol), which is herein incorporated by reference in its entirety, and in the present application.

In a further preferred embodiment, besides the specified fusion partner, the fusion hydrophobin has, as one of the groups Xₙ or Xₘ or as terminal constituent of such a group, also a so-called affinity domain (affinity tag/affinity tail). In a manner known in principle, these are anchor groups which can interact with certain complementary groups and can serve for easier work-up and purification of the proteins. Examples of such affinity domains comprise (His)ₖ, (Arg)ₖ, (Asp)ₖ, (Phe)ₖ or (Cys)ₖ groups, where k is in general a natural number from 1 to 10. Preferably, it may be a (His)ₖ group, where k is 4 to 6. Here, the group Xₙ and/or Xₘ can consist exclusively of such an affinity domain or else a radical Xₙ or Xₘ linked naturally or non-naturally to a hydrophobin is extended by a terminally arranged affinity domain. The hydrophobins used according to the invention can also be modified in their polypeptide sequence, for example by glycosilation, acetylation or else by chemical crosslinking, for example with glutardialdehyde.

One property of the hydrophobins used according to the invention, or derivatives thereof, is the change in surface properties if the surfaces are coated with the proteins. The change in surface properties can be determined experimentally for example by measuring the contact angle of a drop of water before and after coating the surface with the specific protein and calculating the difference between the two measurements. The procedure for measuring contact angles is known in principle to the person skilled in the art. The measurements refer to room temperature and to water drops of 5 μl and the use of glass plates as substrate. The precise experimental conditions for a method, suitable by way of example for measuring the contact angle are laid down in the experimental section. Under the conditions specified therein, the fusion proteins used according to the invention have the property of increasing the contact angle by at least 20°, preferably at least 25°, particularly preferably at least 30°, in each case compared with the contact angle of an identically sized water drop with the uncoated glass surface.

Particularly preferred hydrophobins for carrying out the present invention are the hydrophobins of the type dewA, rodA, hypA, hypB, sc3, basf1, basf2. These hydrophobins including their sequences are disclosed for example in WO 2006/082251 and in the following sequence protocol. Unless stated otherwise, the sequences given below refer to the sequences disclosed in WO 2006/082251. An overview table with the SEQ-ID numbers is given below and in WO 2006/082251 on page 20. According to the invention, the fusion proteins yaad-Xa-dewA-his (SEQ ID NO: 20), yaad-Xa-rodA-his (SEQ ID NO: 22) or yaad-Xa-basf1-his (SEQ ID NO: 24) with the polypeptide sequences given in brackets, and also the nucleic acid sequences coding for these (SEQ ID NO 19, SEQ ID NO 21, SEQ ID NO 23), in particular the sequences according to SEQ ID NO: 19, 21, 23. Within the context of the present invention, preference is given to using the hydrophobin yaad-Xa-dewA-his (SEQ ID NO: 19/SEQ ID NO: 20).

Proteins which are produced starting from the polypeptide sequences depicted in SEQ ID NOs. 20, 22 or 24, as a result of exchange, insertion or deletion of at least one, up to 10, preferably 5, particularly preferably 5%, of all amino acids and which still have at least 50% of the biological property of the starting protein are also particularly preferred embodiments. Biological property of the proteins is understood here as meaning the change in the contact angle by at least 20° as already described.

Derivatives of particular suitability for carrying out the present invention are derivatives derived from yaad-Xa-dewA-his (SEQ ID NO: 20), yaad-Xa-rodA-his (SEQ ID NO: 22) or yaad-Xa-basf1-his (SEQ ID NO: 24) by shortening the yaad fusion partner. Instead of the complete yaad fusion partner (SEQ ID NO: 16) with 294 amino acids, a shortened yaad radical may advantageously be used.

The shortened radical should, however, comprise at least 20, preferably at least 35, amino acids. For example, a shortened radical having 20 to 293, preferably 25 to 250, particularly preferably 35 to 150 and, for example, 35 to 100 amino acids, can be used. A cleavage site between the hydrophobin and the fusion partner or fusion partners can be used to cleave off the fusion partner and to release the pure hydrophobin in underivatized form (for example by BrCN cleavage on methionine, factor Xa, enterokinase, thrombin, TEV cleavage etc.).

Within the context of the invention, preference is given to using the protein yaad40-Xa-dewA-his (SEQ ID NO: 26 herein and in WO 2007/014897, which is incorporated by reference in its entirety), which has a yaad radical shortened to 40 amino acids. The hydrophobins used in the method according to the invention for the cleaning of hydrophobic surfaces can be prepared chemically by known methods of peptide synthesis, such as, for example, by solid-phase synthesis in accordance with Merrifield. Naturally occurring hydrophobins can be isolated from natural sources by means of suitable methods. By way of example, reference may be made to Wosten et. al., Eur. J. Cell. Bio. 63, 122-129 (1994) or WO 1996/41882. A genetic engineering production method for hydrophobins without fusion partner from Talaromyces thermophilus is described in US 2006/0040349.

The preparation of fusion proteins can preferably take place by genetic engineering methods in which one nucleic acid sequence, in particular DNA sequence, coding for the fusion partner and one nucleic acid sequence, in particular DNA sequence, coding for the hydrophobin part are combined such that the desired protein is produced in a host organism as a result of gene expression of the combined nucleic acid sequence. Such a production method is disclosed, for example, by WO 2006/082251 or WO 2006/082253. The fusion partners make the production of the hydrophobins considerably easier. Fusion hydrophobins are produced in the genetic engineering methods with considerably better yields than hydrophobins without fusion partners. The fusion hydrophobins produced by the genetic engineering method form the host organisms can be worked up in a manner known in principle and be purified by means of known chromatographic methods. In one preferred embodiment, the simplified work-up and purification method disclosed in WO 2006/082253, pages 11/12, can be used. For this, the fermented cells are firstly separated off from the fermentation broth and disrupted and the cell debris is separated off from the inclusion bodies.

The latter can advantageously take place by centrifugation. Finally, the inclusion bodies can be disrupted in a manner known in principle, for example by acids, bases and/or detergents in order to release the fusion hydrophobins. The inclusion bodies with the fusion hydrophobins used according to the invention can generally be completely dissolved within ca. 1 hour using just 0.1 m NaOH.

The solutions obtained can—optionally after establishing the desired pH—be used without further purification by carrying out this invention. The fusion hydrophobins can however also be isolated from the solutions as solid. Preferably, the isolation can take place by means of spray granulation or spray drying, as described in WO 2006/082253, page 12. The products obtained by the simplified work-up and purification method comprise, besides remains of cell debris, generally ca. 80 to 90% by weight of proteins. The amount of fusion hydrophobins is generally 30 to 80% by weight, with regard to the amount of all proteins, depending on the fusion construct and fermentation conditions. The isolated products comprising fusion hydrophobins can be stored as solids and be dissolved for use in the media desired in each case.

The fusion hydrophobins can be used as such or else, following cleavage and separation of the fusion partner, as “pure” hydrophobins for carrying out this invention. A cleavage is advantageously carried out after the isolation of the inclusion bodies and their dissolution. In one preferred embodiment of the invention, the hydrophobin used is at least one fusion hydrophobin with a polypeptide sequence selected from the group of yaad-Xa-dewA-his (SEQ ID NO: 20), yaad-Xa-rodA-his (SEQ ID NO: 22) or yaad-Xa-basf1-his (SEQ ID NO: 24) and yaad40-Xa-dewA-his (SEQ ID NO: 26 herein and in WO 2007/014897). Particular preference is given to the use of a fusion hydrophobin with a shortened fusion partner such as protein yaad40-Xa-dewA-his (SEQ ID NO: 26), which has a yaad radical shortened to 40 amino acids.

Various types of antimicrobial substances which are applied to surfaces of substrates have been known for decades. Cationic antimicrobial active ingredients have likewise been used in disinfectants for a long time.

The present invention relates to a method for immobilizing one or more antimicrobial active ingredients on the surface of a substrate comprising the treatment of the surface with at least one hydrophobin (H) and also at least one cationic antimicrobial active ingredient (W).

The present invention relates in particular to a method for immobilizing one or more antimicrobial active ingredients on the surface of a substrate, in which a relatively high molecular weight, cationic compound is used as cationic antimicrobial active ingredient (W), for example a polycationic substance. This may be, e.g. a compound which comprises, e.g., more than 3, in particular more than 5 and often more than 10, cationic groups.

The present invention also relates to a method for immobilizing an antimicrobial active ingredient on the surface of a substrate, in which a low molecular weight, cationic compound is used as cationic antimicrobial active ingredient (W).

The present invention also relates to a method for immobilizing an antimicrobial active ingredient on the surface of a substrate in which a relatively high molecular weight quaternary ammonium compound, a relatively high molecular weight polyiminocarbonyl compound or a relatively high molecular weight polyethyleneimine-peptide conjugate is used as cationic antimicrobial active ingredient (W).

The present invention also relates to a method for immobilizing antimicrobial active ingredients on the surface of a substrate, in which a relatively high molecular weight cationic compound and a low molecular weight cationic compound are used together.

The present invention also relates to a method for immobilizing an antimicrobial active ingredient on the surface of a substrate in which a fusion protein is used as hydrophobin (H).

The present invention relates further to a method for immobilizing as described above comprising the treatment of the surface with at least one composition comprising at least one hydrophobin (H) and/or at least one cationic antimicrobial active ingredient (W).

The present invention relates on the one hand to methods for immobilizing an antimicrobial active ingredient on the surface of a substrate in which the method comprises the following steps:
a) wetting the surface of the substrate with a composition (Z1), comprising the following components:
   (i) at least one solvent (L1),
      where the solvent (L1) comprises at least 60% by weight of water,
   (ii) at least one hydrophobin (H),
   (iii) optionally one or more additives (A),
b) applying an antimicrobial composition (Z2), comprising the following components:
   (i) at least one solvent (L2),
   (ii) at least one cationic antimicrobial active ingredient (W),
   (iii) optionally one or more auxiliary components (HK).

The present invention relates, on the other hand, to methods for immobilizing an antimicrobial active ingredient on the surface of a substrate, in which the method comprises, as one step, the wetting of the surface of the substrate with a composition (Z3) comprising the following components:
(i) at least one solvent (L1),
   where the solvent comprises at least 60% by weight of water,
(ii) at least one hydrophobin (H),
(iii) at least one cationic antimicrobial active ingredient (W),
(iv) optionally one or more additives (A) and/or auxiliary components (HK).

The present invention also relates to a method for immobilizing an antimicrobial active ingredient on the surface of a substrate in which the concentration of the hydrophobin component (H) in the composition (in particular in the compositions (Z1) and/or (Z3)) is 0.05 to 5000 ppm.

The present invention also relates to a method for immobilizing an antimicrobial active ingredient on the surface of a substrate, in which the concentration of the cationic antimicrobial active ingredient (W) in the composition (in particular in the compositions (Z2) and/or (Z3)) is 0.05% by weight to 20% by weight. The concentration of the cationic antimicrobial active ingredient (W) in the composition depends here inter alia on the type of active ingredient (or the combination of active ingredients) and the type of surface to be treated. Often, also 0.05% by weight to 10% by weight of the cationic antimicrobial active ingredient (W) suffice.

The present invention also relates to a method for immobilizing an antimicrobial active ingredient on the surface of a substrate, in which the concentration of the additives (A) in the composition (in particular in the compositions (Z1) and/or (Z3)) is 0.01% by weight to 3% by weight and the concentration of the auxiliary components (HK) in the composition is 0.01% by weight to 3% by weight.

The concentration of the auxiliary component (HK) in the composition depends here inter alia on the type of active ingredient (or the combination of active ingredients), the type of auxiliary component and the type of surface to be treated.

The present invention also relates to a method for immobilizing an antimicrobial active ingredient on the surface of a substrate, in which the surface is a hydrophobic surface made of silicone, or a polymeric or copolymeric plastic from the group polyethylene PE, polypropylene PP, polyvinyl chloride PVC, polyethylene terephthalate PET, polyurethane PUR, linoleum and rubber.

The invention also provides a composition for immobilizing an antimicrobial active ingredient on the surface of a substrate, comprising (or consisting of) the following components:
80 to 99.5% by weight of solvent (L),
0.05 to 20% by weight of at least one cationic antimicrobial active ingredient (W),
0.05 to 5000 ppm of at least one hydrophobin (H),
optionally, 0.01 to 3% by weight of one or more additives (A),
optionally, 0.01 to 3% by weight of one or more auxiliary components (HK),
where the sum of all components is precisely 100% by weight.

Also provided is a composition for immobilizing an antimicrobial active ingredient on the surface of a substrate, comprising (or consisting of) the following components:
80 to 99.95% by weight of solvent (L), where the solvent comprises at least 60% by weight of water,
0.05 to 20% by weight of a cationic antimicrobial active ingredient (W),
0.05 to 5000 ppm of at least one hydrophobin (H),
optionally, 0.01 to 3% by weight of one or more additives (A),
optionally, 0.01 to 3% by weight of one or more auxiliary components (HK),
where the sum of all components is precisely 100% by weight,
and where the weight ratio of cationic antimicrobial active ingredient (W) to
hydrophobin (H) is from 1000:1 to 10:1, and where the antimicrobial active ingredient (W) is a polycationic active ingredient.

The invention also relates to the use of a composition comprising at least one hydrophobin (H) and at least one cationic antimicrobial active ingredient (W) for immobilizing the antimicrobial active ingredient on the surface of the substrate. The use of a composition is also of interest, where the composition comprises a fusion hydrophobin (H) and at least one polycationic antimicrobial active ingredient (W), for immobilizing the polycationic antimicrobial active ingredient on the surface of a plastic substrate.

Typical examples of cationic antimicrobial active ingredients (W) for the purposes of the present invention are:
cationic surfactants, quaternary ammonium compounds, amphoteric surfactants, alkylamines and amine derivatives, cationic polymers, antimicrobial peptides and proteins, peptide mimetics and quaternary phosphonium compounds.

The cationic antimicrobial active ingredients (W) can here be low molecular weight (molecular mass less than 1000 g/mol) (such as, e.g. benzalkonium chloride (284 g/mol) or cetyltrimethylammonium bromide (364 g/mol)).

Further examples of the cationic antimicrobial active ingredients (W) are:

A) Quaternary ammonium compounds,

benzyl-C12-18-alkyldimethylammonium chloride,

benzyl-C12-16-alkyldimethylammonium chloride

di-C8-10-alkyldimethylammonium chloride

C12-14-alkyl[(ethylphenyl)methyl]dimethylammonium chloride and corresponding ammonium compounds with:

(benzylalkyldimethyl (alkyl from C8-C22, saturated and unsaturated, and tallowalkyl, cocoalkyl and soyaalkyl) chlorides, bromides or hydroxides)

(dialkyldimethyl (alkyl from C6-C18, saturated and unsaturated, and tallowalkyl, cocoalkyl and soyaalkyl)chlorides, bromides or methylsulfates)

(alkyltrimethyl (alkyl from C8-C18, saturated and unsaturated, and tallowalkyl, cocoalkyl and soyaalkyl) chlorides, bromides or methylsulfates)

benzalkonium chlorides (alkyldimethylbenzylammonium chloride) alkyldidecylpolyoxethylammonium propionate,

alkyldimethyl compounds alkylbenzylammonium chloride,

alkyldimethylethylammonium chloride,

alkyldidecylpolyoxethylammonium propionate

alkyldimethylalkylbenzylammonium chloride

alkyldimethylethylammonium chloride

alkyldimethylethylbenzylammonium chloride

benzalkonium propionate

cocodimethylbenzylammonium chloride

cocodimethylbenzylammonium chloride,

lauryldimethylbenzylammonium chloride

myristyldimethylbenzylammonium chloride

benzethonium chloride

benzyldihydroxyethylcocoalkylammonium chloride

cocodimethylbenzylammonium chloride

dialkyldimethylammonium chloride

didecylmethyloxyethylammonium propionate

mecetronium ethylsulfate

methylbenzethonium chloride

n-octyl-dimethylbenzylammonium chloride

undecylamidopropyltrimonium methosulfate

oleyltrimethylammonium chloride

dioctyldimethylammonium chloride

didecyldimethylammonium chloride

dicocodimethylammonium chloride

cocobenzyldimethylammonium chloride

cocoalkylbenzyldimethylammonium chloride.

B) Amphoteric surfactants

such as, for example

alkyloligoaminecarboxylic acid

cocamidopropyl betaine

alkyldimethyl betaine

cocoamidopropylhydroxysultaine

dipalmitoyllecithin

alkylbetaines

tallowamphopolycarboxyg lycinate

cocoamphopolycarboxyglycinate

coconut fatty iminopropionate

octyl imino dipropionate

cocoiminoglycinates.

C) Alkylamines and amine derivatives

such as, for example

bis(3-aminopropyl)dodecylamine

n-cocopropylenediammonium borate

dodecylamine sulfamate

n-3-dodecylaminopropylglycine

n-dodecyl-n-(3-aminopropyl)-1,3-propanediamine

glucoprotamine

cocopropylenediamine

cocoaminoacetate.

D) Polymeric cationic antimicrobial active ingredients

such as, for example

dodecyldipropylenetriamine

polylysine

chitosan

polyhexamethylenebiguanide

polyethyleneimine

polymeric, quaternary ammonium compounds

polymeric guanides

polymeric biguanides

polynorbornenes

arylamide oligomers

phenyleneethynylenes

Kenawy et al., 2007 (The Chemistry and Applications of Antimicrobial Polymers: A State-of-the-Art Review) and literature cited therein

polymethacrylates

polymeric, quaternary pyridinium compounds

acyl-lysine oligomers

N-alkylated polyethyleneimines

conjugates of polyethyleneimine and antimicrobial peptides.

E) Antimicrobial peptides and proteins

such as, for example, peptides from the database “The Antimicrobial Peptide Database” (http://aps.unmc.edu/AP/main.php), e.g.

antimicrobial peptide P18

protamine

lysozyme.

F) Peptido mimetics

such as, for example

aminosterols

amphiphilic, cationic, hydrophobic compounds.

G) Quaternary phosphonium compounds

such as, for example

trihexyl(tetradecyl)phosphonium bromide

trihexyl(tetradecyl)phosphonium decanoate

tetradecyl(trihexyl)phosphonium bis(2,4,4-trimethylpentyl)phosphinate

tetradecyl(trihexy)phosphonium dicyanamide

triisobutyl(methyl)phosphonium tosylate

tributyl(methyl)phosphonium methylsulfate

tetradecyl(trihexyl)phosphonium bistriflamide

tetradecyl(trihexyl)phosphonium hexafluorophosphate

tetradecyl(trihexyl)phosphonium tetrafluoroborate

hexadecyl(tributyl)phosphonium bromide

tetrabutylphosphonium bromide

tetrabutylphosphonium chloride

tetra-n-octylphosphonium bromide

tetradecyl(tributyl)phosphonium chloride

ethyl(tributyl)phosphonium diethylphosphate

tetradecyl(tributyl)phosphonium dodecylbenzenesulfonate

tetradecyl(trihexyl)phosphonium dodecylbenzenesulfonate

tetrabutylphosphonium acetate

tetrabutylphosphonium bromide

tetrabutylphosphonium chloride

tetra-n-octylphosphonium bromide

tetradecyl(tributyl)phosphonium chloride

tetradecyl(trihexyl)phosphonium chloride

octadecyl(trioctyl)phosphonium iodide.

The cationic antimicrobial active ingredients (W) are often also relatively high molecular weight (molar mass greater than 1000 g/mol) or high molecular weight, which can further improve the long-term immobilization on the surface.

Examples of cationic antimicrobial active ingredients (W) are in particular quaternary ammonium compounds (so-called “quats”), which are described in the literature, e.g. for the antibacterial finishing of textiles. Substances of this class often cover a broad germ spectrum with an excellent effect. For example, Karl Heinz Wallhäusser, Praxis der Sterilisation Desinfektion—Konservierung [Practice of sterilization disinfection—preservation], 5th edition, Georg Thieme Verlag Stuttgart, New York 1995, page 586 ff. describes this substance class in detail. It is known that quaternary ammonium compounds have a bactericidal effect particularly if at least one of the four substituents on the quaternary nitrogen has a chain length of from 8 to 18 carbon atoms, preferably from 12 to 16 carbon atoms. The other substituents can be e.g. straight or branched alkyl radicals or radicals with heteroatoms or radicals with aromatics. One or more benzyl radicals are also often bonded to the quaternary nitrogen in the molecule. It is also possible to use quaternary ammonium compounds with two methyl groups, one n-alkyl group having between 10 to 18 carbon atoms and a 3-trimethoxysilylpropyl group.

Quaternary ammonium compounds, however, often have the property that they are readily soluble in water. This property is an obstacle to aqueous application in the industrial finishing process. However, at the same time, this property leads to such compounds being rapidly washed off from the substrates since the adhesion to the surface is possible primarily by means of Van-der-Waals forces and optionally ion-pair bonds. In order to improve the resistance on surfaces, the precursors of the quats, namely tertiary amines, can also be quaternized for example with 3-chloropropyltrimethoxysilane. There are, e.g., commercial products with a trimethoxysilylpropyl group on the quaternary nitrogen, where the products can be obtained from the reaction with didecylmethylamine or with tetradecyldimethylamine or from the reaction with octadecyldimethylamine. The quaternization of amines is described, e.g. in DE-A 199 28 127.

Further relatively high molecular weight cationic antimicrobial active ingredients (W) are also polyiminocarbonyl compounds, such as e.g., the known substance polyhexa-methylenebiguanide, which can be described by the following formula:

(—NH—C(═NH)—NH—C(═NH)—NH—(CH₂)₆—)ₙ

Preferably, the cationic antimicrobial active ingredients (W) are polycationic compounds which carry two or more (e.g. more than 5, often more than 10) positively charged groups.

The cationic antimicrobial active ingredients (W) can be e.g. also conjugates from polyethyleneimines with peptides.

The cationic antimicrobial active ingredients (W) kill bacteria and/or prevent their multiplication by interacting with the negatively charged membrane and/or the negatively charged cell wall of the bacteria and in so doing destroying vital processes (such as the maintenance of the membrane gradient). The cationic charge of the antimicrobial active ingredients is essential for the interaction with the negatively charged cell components.

Beside the negatively charged cell components, cationic antimicrobial active ingredients can also bind via electrostatic interactions and/or hydrogen bridges to hydrophilic, anionic surfaces such as cellulose or anionic polyelectrolytes. However, the binding via electrostatic interaction brings about a deactivation of the antimicrobial effect since the cationic charges of the antimicrobial active ingredients are now no longer available for the interaction with the anionic cell components of the bacteria.

Different organisms such as bacteria and fungi have differing sensitivity to different cationic antimicrobial active ingredients. In order to inhibit a non-sensitive organism, a relatively large amount of active ingredient is required. It is therefore particularly advantageous for the antimicrobial finishing of surfaces to apply the largest possible amount of active ingredient durably to the surface and to prevent the active ingredient from being washed off by means of a good and durable immobilization. In this way, it is possible to achieve a good effect against a broad spectrum of different organisms for a prolonged period.

Surprisingly, it has been found that cationic antimicrobial active ingredients can even be adsorbed to hydrophobic polymer surfaces without polar, hydrophilic groups and without anionic charges such that an antimicrobial effect is retained even after intensive washing of the polymer surfaces.

Surfaces of this type can consist of e.g., silicone, linoleum, rubber or plastics, in particular from the group polyethylene PE, polypropylene PP, polyvinyl chloride PVC, polyethylene terephthalate PET, polyurethane PUR. The surfaces here can be planar or else shaped as desired, for example, in the case of surfaces of medical instruments.

Furthermore, it has been found that a hydrophobin coating of surfaces is suitable, despite the anionic charges of the hydrophobin, for improving the binding of the cationic antimicrobial active ingredients on completely different surfaces without deactivating them.

The binding of the active ingredients with the help of hydrophobin leads here to a broadening of the spectrum of activity. In numerous experiments, a synergistic effect with regard to the antimicrobial properties as a result of combining hydrophobin and cationic antimicrobial active ingredient has been observed.

The binding of the cationic antimicrobial active ingredients (W) to the hydrophobin coating can take place as simple adsorption via non-covalent interactions (a) or through a combination of non-covalent and covalent interactions (b). The known hydrophobins bind to a large number of different surfaces. After binding the hydrophobins, the surface properties can be dominated by the properties of the hydrophobins.

The hydrophobin properties normally correspond to the sum of the typical protein properties of the hydrophobins (i) and the properties of individual amino acids or groups of similar amino acids (ii) on the surface of the hydrophobins. The typical protein properties of the hydrophobins (i) also arise from the three-dimensional arrangement of the amino acids. Besides the binding to any desired surfaces, the change in surface polarity associated therewith can be of particular importance here.

As a result of a hydrophobin coating, particularly hydrophobic surfaces can be made more hydrophilic, but in principle hydrophilic surfaces can also be made more hydrophobic. The properties of the amino acids (ii) are essentially determined by their functional groups. Different amino acids have different functional groups, such as e.g. amino functions (lysine), hydroxyl functions (serine, tyrosine), thiols (cysteine and methionine), guanidino function (arginine) and carboxyl functions (glutamate and aspartate). Consequently, as a result of a hydrophobin coating, functional groups and charges are also typically applied to the surfaces. This is of great benefit especially for inert surfaces made of, e.g. silicone, polypropylene, polyethylene, PVC, glass, ceramic, titanium oxide and metals and alloys thereof.

The adsorption (a) of cationic antimicrobial active ingredients normally involves all types of non-covalent interaction (hydrophobic interactions, Van-der-Waals forces, hydrogen bridges and ionic interactions). Here, the ionic interactions can be of particular interest.

Thus, the cationic antimicrobial active ingredients (W) can also be bonded to the surfaces by means of the negative charges of the aspartic acid and glutamic acid radicals of the hydrophobins, without deactivation taking place as a result. The coating of the surfaces by hydrophobins (H) and the bonding of cationic antimicrobial active ingredients can take place in one step (i) or else in two steps (ii).

Accordingly, the present invention comprises a method for immobilizing while applying only one active-ingredient-containing composition, but also a method for immobilizing while applying two active-ingredient-containing compositions.

In the two-step method (ii) of particularly suitability for many surfaces, firstly the step of coating the surface by at least one hydrophobin (H) takes place. For this, the surface is treated, e.g. with a composition (generally aqueous solution) of at least one hydrophobin (H). In a further, separate step, the cationic antimicrobial active ingredient (W) is then applied, e.g. with a composition (generally aqueous solution), and is adsorbed, e.g. non-covalently to the hydrophobin coating. For this, the surface is often brought into contact with a solution of at least one cationic antimicrobial active ingredient (which can also comprise further components).

In the one-step method (i), a composition (often an aqueous solution) of at least one hydrophobin (H) and the cationic antimicrobial active ingredients (W) is prepared and the surface to be treated is treated with this solution. Besides the at least one hydrophobin and the cationic antimicrobial active ingredients, this solution can comprise further substances which are necessary for the specific application and for the stabilization of the solution. The treatment of the surfaces can take place by overlaying, immersion, spin-coating or spraying. Simple adsorption is advantageous particularly in the case of polymeric active ingredients and for applications in which a covalent bonding is not possible.

The simple adsorption of the cationic antimicrobial active ingredients (W) can be intensified by covalent bonding (b). This can be advantageous particularly for low molecular weight active ingredients. For this, the cationic antimicrobial active ingredients can be coupled to the hydrophobins. During the coupling, the functional groups of the hydrophobins (H) or the functional groups of the cationic antimicrobial active ingredients are particularly activated and are then reacted with the respective functional groups of the opposite side.

The coupling can take place to the hydrophobin coating on the surface (ii) or with the free hydrophobins (i). During the coupling to the coating (ii), the hydrophobin is firstly bonded to the surface. The hydrophobin coating or the cationic antimicrobial active ingredient (W) are then activated and then both components mixed together. Alternatively, the cationic, antimicrobial active ingredient (W) can also firstly be adsorbed only to the coating, and the covalent bond can then be joined.

During the coupling to the free hydrophobin (i) hydrophobin-active ingredient conjugates are prepared in solution which can then be adsorbed to the surface. The synthesis of the hydrophobin-active ingredient conjugates likewise takes place by activation of the functional groups of the hydrophobins or of the cationic antimicrobial active ingredients.

The activation of the functional groups can take place by crosslinking substances (crosslinkers). Here, the choice of crosslinker is governed by the type of functional groups to be coupled. Suitable for the coupling of amines are, for example:
imido ester crosslinkers, N-hydroxysuccinimide crosslinkers and other amino-reactive crosslinkers.

Suitable for the coupling of amines to thiols are, for example:
bifunctional N-hydroxysuccinimide haloacetyl crosslinkers,
N-hydroxysuccinimide-maleinimide crosslinkers and
N-hydroxysuccinimide-pyridyldithiol crosslinkers.

For the coupling of carboxyl functions to amines, it is possible to use, e.g.:
carbodiimides such as 1-ethyl-3-[3-dimethylaminopropyl]carbodiimides,
hydrochlorides or N,N′-dicyclohexylcarbodiimides in combination with
N-hydroxysuccinimides or N-hydroxysulfosuccinimides.

With the help of hetero-bifunctional N-[p-maleimidophenyl]isocyanates, hydroxyl functions and thiols can be conjugated.

Suitable for coupling two thiols are bifunctional crosslinkers with maleimide or pyridyldithiol functionalities.

The described methods permit numerous technical applications, for example:
antimicrobial finishing of floor coverings or medical equipment such as implants, catheters, stents and endotracheal tubes
antimicrobial finishings of textiles, filters and non-wovens
depositioning and immobilization of biocidal (in particular antibacterial) components of disinfectant cleaners and hand disinfectants
depositioning and immobilization of biocides from mouth rinses, toothpastes and other products for oral care
depositioning and immobilization of biocides from creams, shampoos, shower gels and other cosmetic products
depositioning and immobilization of biocides from hygiene rinses and other antimicrobial products for laundry hygiene.

In the following the assignment of the sequence names to DNA and polypeptide sequences is listed in the sequence listing.

| | |
|---|---|
| dewA DNA and polypeptide sequence | SEQ ID NO: 1 |
| dewA polypeptide sequence | SEQ ID NO: 2 |
| rodA DNA and polypeptide sequence | SEQ ID NO: 3 |
| rodA polypeptide sequence | SEQ ID NO: 4 |
| hypA DNA and polypeptide sequence | SEQ ID NO: 5 |
| hypA polypeptide sequence | SEQ ID NO: 6 |
| hypB DNA and polypeptide sequence | SEQ ID NO: 7 |
| hypB polypeptide sequence | SEQ ID NO: 8 |
| sc3 DNA and polypeptide sequence | SEQ ID NO: 9 |
| sc3 polypeptide sequence | SEQ ID NO: 10 |
| basf1 DNA and polypeptide sequence | SEQ ID NO: 11 |
| basf1 polypeptide sequence | SEQ ID NO: 12 |
| basf2 DNA and polypeptide sequence | SEQ ID NO: 13 |
| basf2 polypeptide sequence | SEQ ID NO: 14 |
| yaad DNA and polypeptide sequence | SEQ ID NO: 15 |
| yaad polypeptide sequence | SEQ ID NO: 16 |
| yaae DNA and polypeptide sequence | SEQ ID NO: 17 |
| yaae polypeptide sequence | SEQ ID NO: 18 |
| yaad-Xa-dewA-his DNA and polypeptide sequence | SEQ ID NO: 19 |
| yaad-Xa-dewA-his polypeptide sequence | SEQ ID NO: 20 |
| yaad-Xa-rodA-his DNA and polypeptide sequence | SEQ ID NO: 21 |
| yaad-Xa-rodA-his polypeptide sequence | SEQ ID NO: 22 |
| yaad-Xa-basf1-his DNA and polypeptide sequence | SEQ ID NO: 23 |
| yaad-Xa-basf1-his polypeptide sequence | SEQ ID NO: 24 |
| yaad40-Xa-dewA-his DNA and polypeptide sequence | SEQ ID NO: 25 |
| yaad40-Xa-dewA-his polypeptide sequence | SEQ ID NO: 26 |

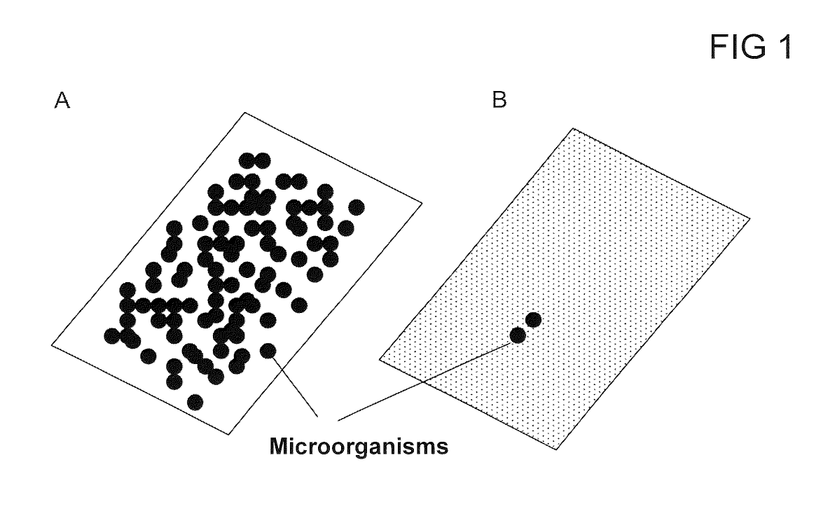

The invention is illustrated by the attached figures, FIG. 1 to FIG. 8, and also by the examples below.

The graphical depiction in FIG. 1 shows diagrammatically the effect of the antimicrobial finishing on the colonization of the surface of a substrate by microorganisms. The left-hand side (A) shows diagrammatically that the surface without antimicrobial finishing is heavily colonized by microorganisms (black dots). The microorganisms form a biofilm which is firmly anchored to the surface. The right-hand side (B) shows that, following antimicrobial finishing of the surface, the microorganisms which try to colonize the surface have been killed. the number of microorganisms on the surface finished with the composition according to the invention (cfu/cm²) is considerably less than in the case of the untreated surface. Ideally, the colonization is prevented completely by the antimicrobial finishing. In the depicted diagrammatic case, a few living microorganisms are still present on the treated surface.

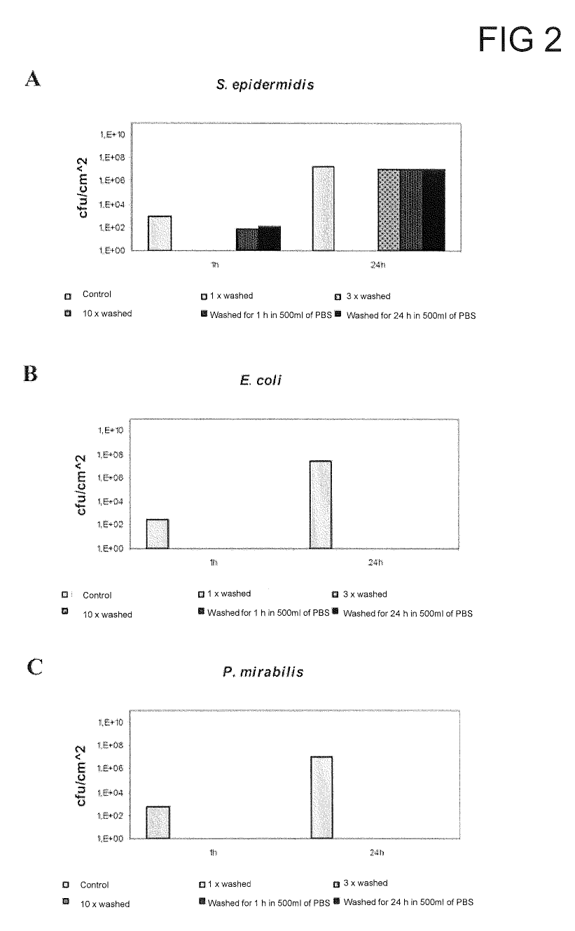

The graphical depiction in FIG. 2 shows the anti-biofilm activity of silicon surfaces following adsorption of the active ingredient polyhexamethylenebiguanide (Reputex 20).

FIG. 2A shows the number of germs (cfu/cm²) of Staphylococcus epidermidis (DSM 1798); FIG. 2B shows E. coli; FIG. 2C shows P. mirabilis. Without washing, with 1× washing and 3× washing, and also 1 hour and 24 hours in PBS (phosphate based saline solution) are shown.

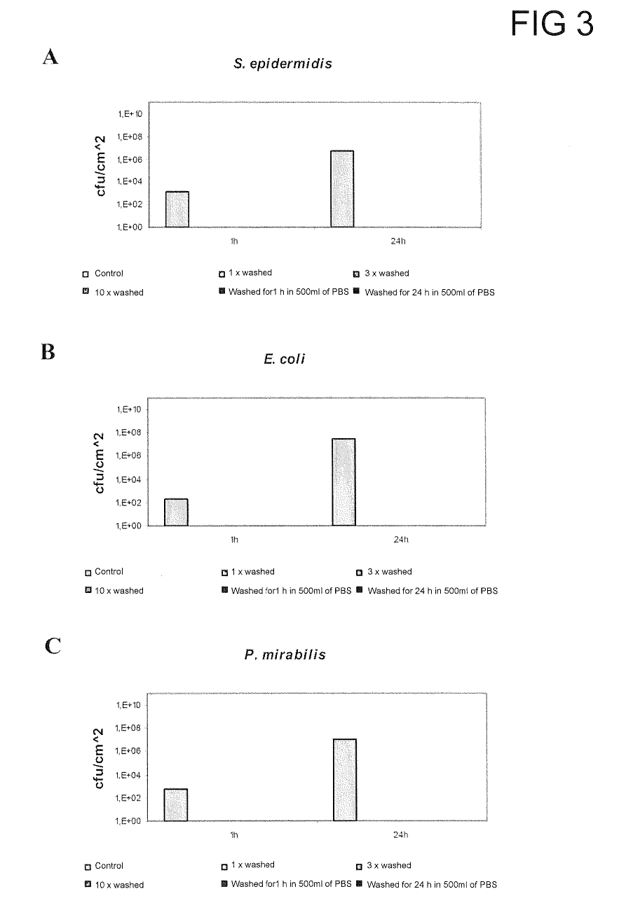

The graphical depiction in FIG. 3 shows the anti-biofilm activity of silicone surfaces following adsorption of Reputex 20 with the help of hydrophobin A. FIG. 3A shows S. epidermidis, FIG. 3B shows E. coli, FIG. 3C shows P. mirabilis.

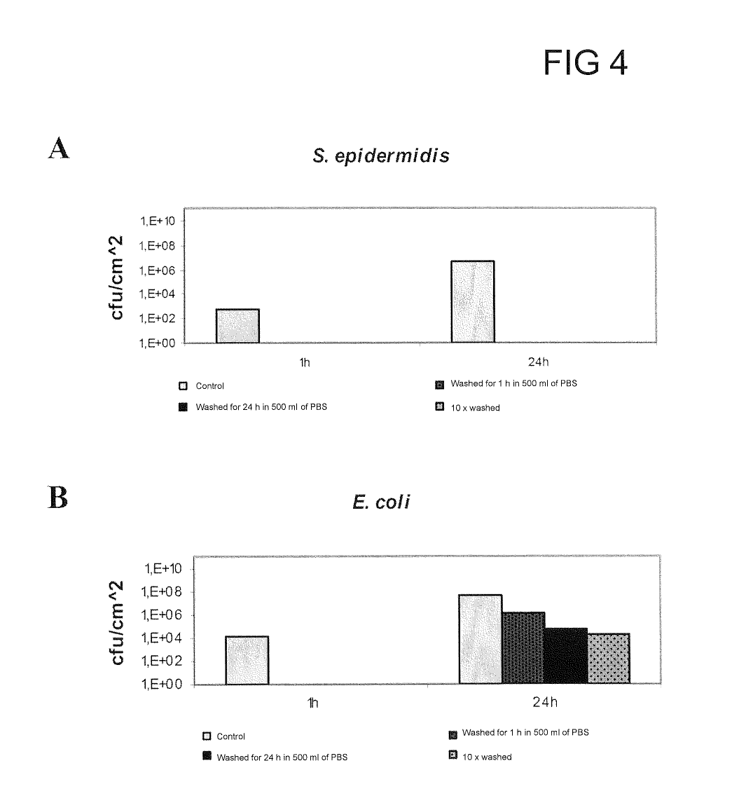

The graphical depiction in FIG. 4 shows the anti-biofilm activity of silicone surfaces following adsorption of the active ingredient component PEI-P18 conjugate. FIG. 4A shows S. epidermidis, FIG. 4B shows E. coli.

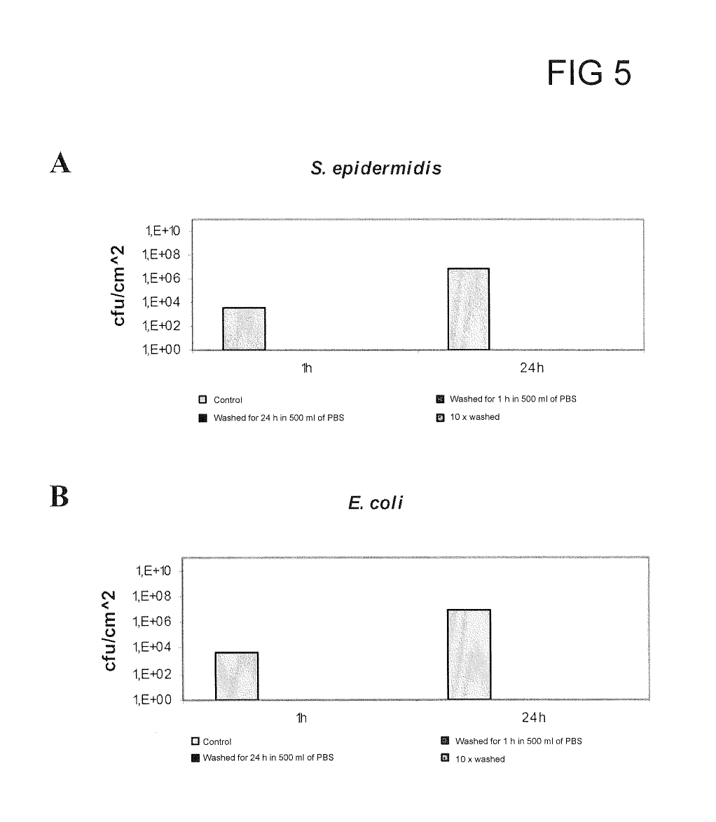

The graphical depiction in FIG. 5 shows the anti-biofilm activity of silicone surfaces following adsorption of the active ingredient component PEI-P18 conjugate with the help of hydrophobin. FIG. 5A shows S. epidermidis, FIG. 5B shows E. coli.

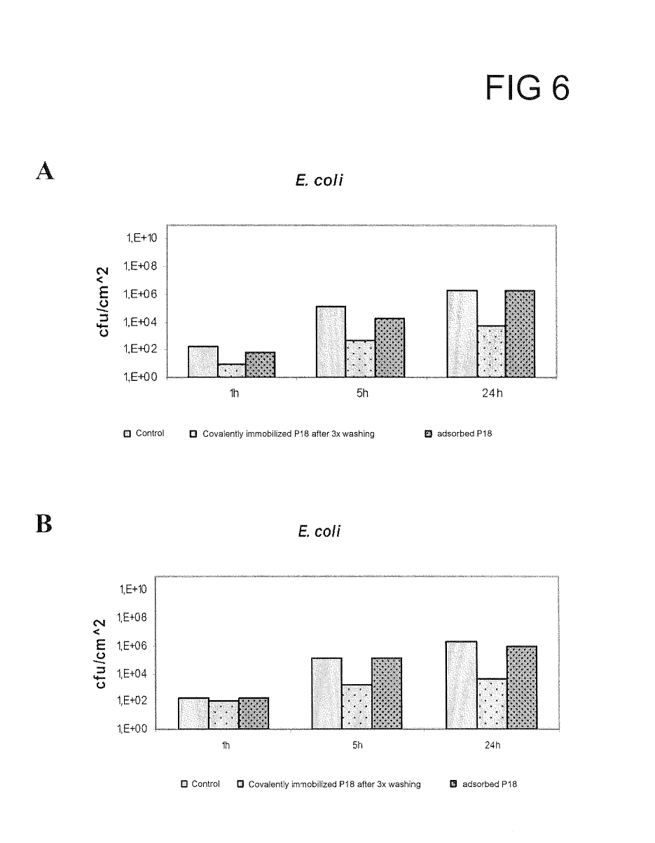

The graphical depiction in FIG. 6 shows the anti-biofilm activity of silicone surfaces against E. coli following adsorption and covalent bonding of the antimicrobial peptide P18 with the help of hydrophobin A. FIG. 6A shows the number of germs after 3× washing with PBS before the biofilm assay, FIG. 6B shows after 10× washing with PBS before the biofilm assay. The control is a silicone surface without antimicrobial finishing for the normal biofilm development. A further control is adsorbed P18 without covalent bonding.

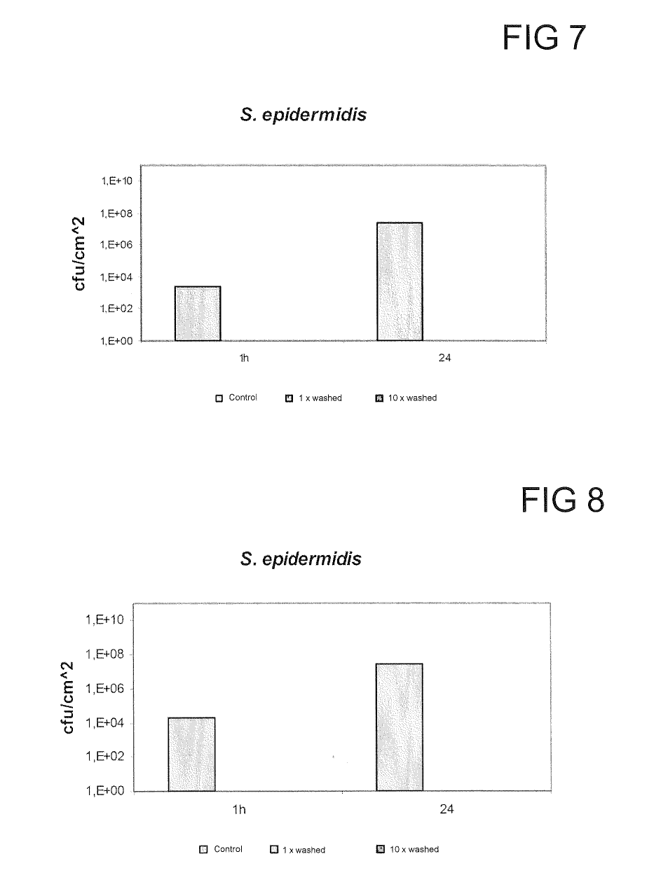

The graphical depiction in FIG. 7 shows the anti-biofilm activity of silicone surfaces against S. epidermidis following adsorption of polyhexamethylenebiguanide (Reputex 20) with the help of hydrophobin B in a one-step method. The silicone surfaces were incubated with an aqueous solution comprising 500 ppm of hydrophobin B and 2% Reputex 20 at pH 4.

The graphical depiction in FIG. 8 shows the anti-biofilm activity of silicone surfaces against S. epidermidis following adsorption of Reputex 20 with the help of hydrophobin B in a one-step method. The silicone surfaces were incubated with an aqueous solution comprising 100 ppm of hydrophobin B, 1% Reputex 20 and 0.3% of Luviquat hold at pH 6.

### EXAMPLE 1

### Testing the Effect of the Antimicrobial Finishing

The effect of the antimicrobial finishing of the investigated surfaces was determined by means of a statistical biofilm assay. For this, the surfaces to be tested were cut into round disks which fit into the holes of 24-well microtiter plates. In order to prevent the surfaces from slipping during the assay, the surfaces were immobilized on the bottom of the microtiter plates with the help of glass joint grease.

The formation of biofilms was carried out starting from a preculture. For this, 20 ml of the standard commercial TSBY medium (Difco Laboratories, MI, USA) were inoculated with the help of a steady-state overnight culture of Staphylococcus epidermidis DSM1798, Escherichia coli DSM 5698, Proteus mirabilis DSM 4479 or Escherichia coli BL21 (DE3) with an optical density of 0.1. The preculture was incubated for 2 to 4 hours with agitation (at 200 rpm) and 37° C. until an optical density of from 2 to 3 was reached. In order to start the biofilm assay, the preculture was diluted to an optical density of 0.0004 in 5% TSBY in saline (0.9% NaCl) (ca. 10⁵ cfu/ml). 1 ml of this was placed onto the surfaces in the 24-well plate and then incubated at 37° C. with gentle vibration at 50 rpm (revolutions per minute), so that a biofilm could form on the surface.

The biofilm on the surfaces was analyzed after one hour (1 h) and after 24 hours (24 h) (and optionally 5 hours). For this, the planktonic cells were removed. The surfaces were then removed from the microtiter plate and briefly washed in sodium chloride solution, saline (0.9% NaCl). The adherent cells in the biofilm were then detached from the surface by means of an ultrasound treatment. For this purpose, the surfaces were transferred to a Falcon tube (50 ml volume) with 2 ml of saline and subjected to ultrasound for five minutes in an ultrasound water bath. The resulting bacterial suspension was diluted and plated out on TSBY agar plates. After 18 hours at 37, the resulting colonies were counted and back-calculated to the number of cells on the surface.

### EXAMPLE 2

### Antimicrobial Finishing of Silicone through Adsorption of PHMB

Prior to the adsorption, the silicone surfaces (disks with a diameter of 15 mm suitable for 24 well microtiter plates) were washed twice with the help of an SDS solution (10 mg/ml in ultra-pure water). Rinsing was then carried out twice with ultra-pure water and the surfaces were degreased by dipping into ethanol (70% in ultra-pure water), sterilized and then dried.

The adsorption of the antimicrobial active ingredient (W), here of the active ingredient polyhexamethylenebiguanide (also PHMB or Reputex 20 as 20% solution) was carried out following dilution to 50 mg/ml in PBS (phosphate-based saline solution). The silicone surfaces to be coated were incubated with the Reputex 20 solution for 1 hour at 400 rpm on the Eppendorf shaker. The surfaces were then dried.

In order to test how durably the cationic antimicrobial active ingredient has been bonded to the surface, the surfaces were washed prior to the biofilm assay in accordance with various protocols. The surfaces were washed in each case once, three times and ten times using 1 ml of PBS. For this, the surfaces were shaken for one minute in each washing step in the Eppendorf shaker at 400 rpm (revolutions per minute). The washing solution was then removed, discarded and replaced with new. Furthermore, the antimicrobially finished surfaces were incubated in 500 ml of PBS for one hour and 24 hours.

The effect of the antimicrobially equipped surfaces was determined as described in Example 1. As a result of the adsorption of polyhexamethylenebiguanide, silicone surfaces can be antimicrobially finished. The antimicrobial finishing is able to prevent the biofilm formation due to Escherichia coli and Proteus mirabilis even after intensive washing. Here, the active ingredient which remains on the surface after washing suffices to completely prevent the formation of biofilm. The biofilm formation due to Staphylococcus epidermidis can no longer be completely suppressed following intensive washing of the surfaces. Here, the amount of active ingredient which remains on the surface is insufficient to still have the ability to be effective.

FIG. 2 shows graphically the anti-biofilm activity of silicone surfaces (number of germs in cfu/cm² following adsorption of polyhexamethylenebiguanide for three organisms (in each case compared to the control (without active ingredients):
A S. epidermidis,
B E. coli,
C P. mirabilis.

The immobilization of the antimicrobial active ingredient is insufficient.

### EXAMPLE 3

### Antimicrobial Finishing of Silicone Surfaces by Adsorption of Polyhexamethylenebiguanide with the Help of Hydrophobin A in the Two-Step Method

The antimicrobial finishing of the silicone surfaces was carried out in two steps. In the first step the hydrophobin A was bonded to silicone as hydrophobin component (H). For this purpose, the surfaces were incubated with 0.5 mg/ml of hydrophobin A in binding buffer (50 mM Tri-HCl, 1 mM CaCl₂ at pH 8.0) for at least 3 hours. Preferably, the hydrophobin yaad-Xa-dewA-his (SEQ ID NO: 20) (see WO 2006/082251) is used here. Washing is then carried out twice with ultra-pure water and the surface is dried.

In the second step, polyhexamethylenebiguanide (Reputex 20) was absorbed onto the hydrophobin coating. For this purpose, the surfaces were overlaid in each case with 1 ml of 50 mg/ml Reputex 20 in PBS and incubated for one hour at room temperature. Washing was then carried out once with 1 ml of ultra-pure water.

In order to test how durably the cationic antimicrobial active ingredient was bonded to the surface, the surfaces were washed prior to the biofilm assay in accordance with various protocols. The surfaces were washed in each case, once, three times and ten times with 1 ml of PBS. For this purpose, the surfaces were shaken during each washing step for one minute in an Eppendorf shaker at 400 rpm (revolutions per minute). The washing solution was then removed, discarded and replaced with new. The antimicrobially finished surfaces were furthermore incubated for one hour and 24 hours in 500 ml of PBS.

The effect of the antimicrobially equipped surfaces was determined as described in Example 1. In contrast to Example 2, the antimicrobial finishing as a result of adsorption of the antimicrobial active ingredient with the help of hydrophobin A is effective even after intensive washing against the formation of biofilm due to S. epidermidis. As a result of the hydrophobin coating, polyhexamethylenebiguanide is better retained on the surface, meaning that, even after intensive washing, enough active ingredient is present to prevent the formation of biofilm due to S. epidermidis.

FIG. 3 shows the anti-biofilm activity of silicone surfaces after adsorption of polyhexamethylenebiguanide with the help of hydrophobin A for a variety of microorganisms, where improved fixing of the active ingredient could be observed.
A S. epidermidis,
B E. coli,
C P. mirabilis.

### EXAMPLE 4

### Synthesis of PEI-P18 Conjugates

The synthesis of the polyethylenimine-P18 conjugates used as cationic antimicrobial active ingredient (W) was carried out by activating polyethyleneimine (PEI) with succinimidyl-4-[N-maleimidomethyl]cyclohexane-1-carboxylate (SMMC) and subsequent reaction with P18cys. P18cys corresponds to the amino acid sequence of P18 with an additional C-terminal cysteine radical (KWKLFKKIPKFLHLAKKFC; SEQ ID NO: 27). P18cys was prepared by synthesis (e.g. by Bachem A G, Bubendorf, Switzerland). SMCC is a hetero-bifunctional crosslinker with an amino-reactive and a thiol-reactive component.

In the first step, the amino functions of the PEI (supplier, e.g. Sigma-Aldrich 408727; 25 KDa) were activated with SMCC. For this, the PEI was diluted to 100 mg/ml in PBS (Phosphate Buffered Saline: 10 mM potassium phosphate, 137 mM NaCl, pH 7.5), the pH was adjusted to 7 to 8 with 4 M HCl and this solution was then dialyzed overnight against PBS. The PEI treated in this way was then incubated at a concentration of 10 mg/ml in a volume of 1 ml of PBS with 45 mM SMCC for two hours at room temperature. After the end of the incubation, resulting opacities were centrifuged off and any not fully reacted amino-reactive functions of the SMCC were quenched by adding 180 mM glycine. The supernatant with dissolved PEI-SMCC was reacted with P18cys. For this, 1.1 mg/ml of PEI-SMCC were incubated in a volume of 1 ml with 5 mM P18cys overnight at room temperature.

Uncoupled P18cys and low molecular weight substances were removed by dialysis against PBS. The PEI-P18 conjugates were analyzed by SDS-Page methods.

### EXAMPLE 5

### Antimicrobial Finishing of Silicone Surfaces by Adsorption of PEI-P18 Conjugates

The PEI-P18 conjugates synthesized as in example 4 were adsorbed to silicone surfaces as the active ingredient component. Prior to the adsorption, the silicone surfaces (disks with a diameter of 15 mm suitable for 24-well microtiter plates) were washed twice with the help of an SDS solution (10 mg/ml in ultra-pure water). Rinsing was then carried out twice with ultra-pure water and the surfaces were degreased by dipping into ethanol (70% in ultra-pure water), sterilized and then dried. The adsorption of the conjugates was carried out from a solution with 10 mg/ml (P18 equivalents) in PBS. The silicone surfaces to be coated were incubated with the solution for one hour at 400 rpm on the Eppendorf shaker. The surfaces were then dried.

In order to test how durably the cationic antimicrobial active ingredients have been bonded to the surface, the surfaces were washed before the biofilm assay in accordance with various protocols. The surfaces were washed ten times with 1 ml of PBS. For this, the surfaces were shaken for each washing step for one minute in an Eppendorf shaker at 400 rpm (revolutions per minute). The washing solution was then removed, discarded and replaced with new. Furthermore, the antimicrobially finished surfaces were incubated in 500 ml of PBS for one hour and 24 hours.

The effect of the antimicrobially equipped surfaces was determined as described in example 1. As a result of the adsorption of PEI-P18 conjugates, silicone surfaces can be antimicrobially finished. The antimicrobial finishing is able to prevent the formation of a biofilm due to S. epidermidis even after washing. Here, the active ingredient which remains on the surface after the washing suffices to prevent biofilm formation. However, the PEI-P18 conjugates are not retained on the surface so strongly that after intensive washing enough active ingredient is present to prevent biofilm formation by E. coli.

FIG. 4 shows the anti-biofilm activity of silicone surfaces after adsorption of antimicrobial PEI-P18 conjugates on to:
A S. epidermidis,
B E. coli.

### EXAMPLE 6

### Antimicrobial Finishing of Silicone Surfaces through Adsorption of PEI-P18 Conjugates with the Help of Hydrophobin

The antimicrobial finishing of silicone surfaces was carried out in two steps. In the first step, hydrophobin A was bonded to silicone. For this, the surfaces were incubated for at least 3 hours with 0.5 mg/ml of hydrophobin A in binding buffer (50 mM Tri-HCl, 1 mM CaCl₂ at pH 8.0). Washing was then carried out twice with ultra-pure water and the surface was dried. The adsorption of the conjugates was carried out in the second step from a solution with 10 mg/ml (P18 equivalents) in PBS. The silicone surfaces to be coated were incubated with the solution for one hour at 400 rpm on the Eppendorf shaker. The surfaces were then dried.

In order to test how durably the cationic antimicrobial active ingredients were bonded to the surface, the surfaces were washed before the biofilm assay in accordance with various protocols. The surfaces were washed ten times with 1 ml of PBS. For this, the surfaces were shaken in each washing step for 1 minute in the Eppendorf shaker at 400 rpm. The washing solution was then removed, discarded and replaced by new. Furthermore, the antimicrobially finished surfaces were incubated for one hour and 24 hours in 500 ml of PBS.

The effect of the antimicrobially equipped surfaces was determined as described in Example 1. In contrast to example 5, the antimicrobial finishing as a result of adsorption of the PEI-P18 conjugates with the help of hydrophobin A is effective even after intensive washing against biofilm formation by E. coli. As a result of the hydrophobin coating, the PEI-P18 conjugates are retained on the surface so durably that even after intensive washing, enough active ingredient is present to prevent biofilm formation by E. coli.

FIG. 5 shows the anti-biofilm activity of silicone surfaces following adsorption of PEI-P18 conjugates with the help of hydrophobin in the case of:
A S. epidermidis,
B E. coli.

Improved immobilization of the active ingredient on the surface was established.

### EXAMPLE 7

### Antimicrobial Finishing of Silicone by Adsorption and Covalent Linkage with the Antimicrobial Peptide P18

The peptide P18 was covalently bonded to an existing hydrophobin coating on silicone surfaces (disks with a diameter of 15 mm suitable for 24-well microtiter plates). For this, the amino functions of the hydrophobin on the surface were activated by EDC in the presence of NHS. The activation was carried out by incubating the hydrophobin coating on the silicone surfaces in 24-well plates for 30 minutes at room temperature in a solution of 760 μl of ultra-pure water, 40 μl of MES buffer (20 mM, pH 6), 100 μl of EDC (250 mM, pH 6 to 6.8) and 100 μl of NHS (250 mM, pH 7.0 to 8.0). 100 μl of P18 solution (10 mM of P18 in 100 mM of NaCO₃, pH 8.5) were then added and incubated for a further 60 minutes at room temperature. At the end of the reaction, washing was carried out with ultra-pure water.

FIG. 6 shows the anti-biofilm activity of silicone surfaces against E. coli after adsorption and covalent bonding of the antimicrobial peptide P18 with the help of hydrophobin A:
A 3× washing with PBS before the biofilm assay,
B 10× washing with PBS before the biofilm assay.

Control=Silicone surface without antimicrobial finishing for the normal biofilm development. Further control=adsorbed P18 without covalent bonding.

In order to test how durably the cationic antimicrobial active ingredients have been bonded to the surface, the surfaces were washed three times and ten times with in each case 1 ml of PBS before the biofilm assay. For this purpose, the surfaces were shaken in each washing step for one minute in an Eppendorf shaker at 400 rpm. The washing solution was then removed, discarded and replaced by new.

The effect of the antimicrobially equipped surfaces was determined as described in Example 1 (FIG. 6). Additionally, the biofilm formation was also measured after 5 hours. Whereas the samples on which the antimicrobial peptide has been immobilized without covalent bonding no longer exhibit an effect after washing three times and ten times, a clear reduction in biofilm formation of E. coli on the silicone surfaces with covalently immobilized P18 is evident.

### EXAMPLE 8

### Antimicrobial Finishing of Silicone Surfaces in a One-Step Method through Simultaneous Treatment with Polyhexamethylenebiguanide and Hydrophobin B

The antimicrobial finishing of the silicone surfaces was carried out in the one-step method. Two aqueous compositions were prepared:
a) which comprises, as hydrophobin component (H), 500 ppm of the hydrophobin B (see WO 2006/082251) and also 2.0% by weight of polyhexamethylenebiguanide (Reputex 20),
b) which comprises, as hydrophobin component (H), 100 ppm of the hydrophobin B, and also 1.0% by weight of polyhexamethylenebiguanide (Reputex 20) and 0.3% by weight of an additive (Ludiquat Hold).

The antimicrobial finishing of the silicone-surfaces takes place in one step. For this purpose, the surfaces were incubated for 1 h with 1 ml of a solution of 500 ppm of hydrophobin B and 2% Reputex 20 at pH 4. The surfaces were then dried.

In order to test how durably the active ingredient (W) polyhexamethylenebiguanide was bonded to the surface, the finished surfaces were washed before the biofilm assay in each case once and ten times with 1 ml of PBS. For this, the surfaces were shaken in each washing step for one minute in an Eppendorf shaker at 400 rpm (revolutions per minute). The washing solution was then removed, discarded and replaced with new. The effect of the antimicrobially equipped surfaces was determined analogously to example 1 (see FIG. 7). FIG. 7 shows the anti-biofilm activity of silicone surfaces against S. epidermidis following adsorption of Reputex 20 with the help of hydrophobin B in the one-step method. The silicone surfaces were incubated with an aqueous solution comprising 500 ppm of hydrophobin B and 2% of Reputex 20 at pH 4.

The antimicrobial finishing of the silicone surfaces by adsorption of Reputex 20 with the help of hydrophobin B in the one-step method exhibits a similarly good effect as the adsorption with the help of hydrophobin A in the two-step method described in example 3.

Even after intensive washing, the biofilm formation due to S. epidermidis can still be completely prevented. With hydrophobin B as well, in the one-step method, an active ingredient such as polyhexamethylenebiguanide can be adsorbed so readily that after intensive washing, adequate active ingredient is still present to completely prevent the formation of biofilm due to S. epidermidis.

### EXAMPLE 9

### Antimicrobial Finishing of Silicone Surfaces in the One-Step Method by Simultaneous Treatment with Polyhexamethylenebiguanide, Hydrophobin B and an Auxiliary Component (HK)

The antimicrobial finishing of the silicone surfaces was carried out in a one-step method. In the one-step method, auxiliaries such as, e.g., cationic, zwitterionic or nonionic surfactants or polymers can also be used.

Thus, through adsorption of polyhexamethylenebiguanide (Reputex 20) from an aqueous solution comprising 100 ppm of hydrophobin B, 1% Reputex 20 and 0.3% of the surfactant “Luviquat hold” at pH 6, it was likewise possible to completely prevent the formation of biofilm by S. epidermidis on silicone surfaces.

Here, the adsorption took place as described in example 8. As in Examples 8 and 3, the biofilm formation could be completely prevented even after intensive washing (see FIG. 8). FIG. 8 shows the anti-biofilm activity of silicone surfaces against S. epidermidis following adsorption of Reputex 20 with the help of hydrophobin B in a one-step method. The silicone surfaces were incubated with a solution of 100 ppm of hydrophobin B, 1% of Reputex 20 and 0.3% of Luviquat hold at pH 6.

We claim:

1. A method for immobilizing an antimicrobial active ingredient on a surface of a substrate comprising treating the surface with a hydrophobin and a cationic antimicrobial active ingredient.

2. The method of claim 1, wherein the cationic antimicrobial active ingredient is a relatively high molecular weight, cationic compound.

3. The method of claim 1, wherein the cationic antimicrobial active ingredient is a low molecular weight, cationic compound.

4. The method of claim 1, wherein the cationic antimicrobial active ingredient is selected from the group consisting of a relatively high molecular weight quaternary ammonium compound, a relatively high molecular weight polyiminocarbonyl compound and a relatively high molecular weight polyethyleneimine-peptide conjugate.

5. The method of claim 1, wherein the hydrophobin is a fusion hydrophobin.

6. The method of claim 1, wherein the method further comprises
a) wetting the surface of the substrate with a composition comprising
(i) a solvent, where the solvent comprises at least 60% by weight of water,
(ii) a hydrophobin and
(iii) optionally, one or more additives,
b) applying an antimicrobial composition comprising
(i) a solvent,
(ii) a cationic antimicrobial active ingredient and
(iii) optionally, one or more auxiliary components.

7. The method of claim 6, wherein the concentration of the additives in the composition is 0.01% by weight to 3% by weight of the composition and the concentration of auxiliary components in the composition is 0.01% by weight to 3% by weight of the composition.

8. The method of claim 1, wherein the method further comprises, as one step, wetting the surface of the substrate with a composition comprising
(i) a solvent, where the solvent comprises at least 60% by weight of water,
(ii) a hydrophobin,
(iii) a cationic antimicrobial active ingredient and
(iv) optionally, one or more additives or auxiliary components.

9. The method of claim 8, wherein the concentration of the additives in the composition is 0.01% by weight to 3% by weight of the composition and the concentration of auxiliary components in the composition is 0.01% by weight to 3% by weight of the composition.

10. The method of claim 1, wherein the concentration of the hydrophobin in the composition is 0.05 ppm to 5000 ppm.

11. The method of claim 1, wherein the concentration of the cationic antimicrobial active ingredient in the composition is 0.05% by weight to 20% by weight of the composition.

12. The method of claim 1, wherein the surface is a hydrophobic surface made of silicone, linoleum, rubber or a polymeric plastic selected from the group consisting of polyethylene PE, polypropylene PP, polyvinyl chloride PVC, polyethylene terephthalate PET and polyurethane PUR.

13. A composition for immobilizing an antimicrobial active ingredient on the surface of a substrate comprising
80% to 99.5% by weight of a solvent,
0.05% to 20% by weight of a cationic antimicrobial active ingredient,
0.05 ppm to 5000 ppm of a hydrophobin,
optionally, 0.01% to 3% by weight of one or more additives and
optionally, 0.01% to 3% by weight of one or more auxiliary components,
wherein the sum of all components of the composition is 100% by weight of the composition.

14. The composition of claim 13 consisting of
80% to 99.95% by weight of the solvent, wherein the solvent comprises at least 60% by weight of water,
0.05% to 20% by weight of the cationic antimicrobial active ingredient,
0.05 ppm to 5000 ppm of the hydrophobin,
optionally, 0.01% to 3% by weight of the one or more additives and
optionally, 0.01% to 3% by weight of the one or more auxiliary components,
wherein the weight ratio of the cationic antimicrobial active ingredient to the hydrophobin is 1000:1 to 10:1, and wherein the antimicrobial active ingredient is a polycationic active ingredient.

15. The composition of claim 13, wherein the hydrophobin is a fusion hydrophobin.

16. The composition of claim 14, wherein the hydrophobin is a fusion hydrophobin.


SEQUENCE LISTING (27 sequences)

SEQ ID NO: 1 - DNA, 405 bp, Aspergillus nidulans
  CDS (1)..(405): dewA hydrophobin
atgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgag

SEQ ID NO: 2 - protein, 135 aa, Aspergillus nidulans
  dewA hydrophobin
MRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAE

SEQ ID NO: 3 - DNA, 471 bp, Aspergillus nidulans
  CDS (1)..(471): rodA hydrophobin
atgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctc

SEQ ID NO: 4 - protein, 157 aa, Aspergillus nidulans
  rodA hydrophobin
MKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSIL

SEQ ID NO: 5 - DNA, 336 bp, Artificial Sequence
  CDS (1)..(336): hypA from chemically synthesized polynucleotide
atgatctctcgcgtccttgtcgctgctctcgtcgctctccccgctcttgttactgcaactcctgctcccggaaagcctaaagccagcagtcagtgcgacgtcggtgaaatccattgctgtgacactcagcagactcccgaccacaccagcgccgccgcgtctggtttgcttggtgttcccatcaaccttggtgctttcctcggtttcgactgtacccccatttccgtccttggcgtcggtggcaacaactgtgctgctcagcctgtctgctgcacaggaaatcaattcaccgcattgattaacgctcttgactgctctcctgtcaatgtcaacctc

SEQ ID NO: 6 - protein, 112 aa, Artificial Sequence
  hypA from chemically synthesized polynucleotide
MISRVLVAALVALPALVTATPAPGKPKASSQCDVGEIHCCDTQQTPDHTSAAASGLLGVPINLGAFLGFDCTPISVLGVGGNNCAAQPVCCTGNQFTALINALDCSPVNVNL

SEQ ID NO: 7 - DNA, 357 bp, Artificial Sequence
  CDS (1)..(357): hypB from chemically synthesized polynucleotide
atggtcagcacgttcatcactgtcgcaaagacccttctcgtcgcgctcctcttcgtcaatatcaatatcgtcgttggtactgcaactaccggcaagcattgtagcaccggtcctatcgagtgctgcaagcaggtcatggattctaagagccctcaggctacggagcttcttacgaagaatggccttggcctgggtgtccttgctggcgtgaagggtcttgttggcgcgaattgcagccctatcacggcaattggtattggctccggcagccaatgctctggccagaccgtttgctgccagaataataatttcaacggtgttgtcgctattggttgcactcccattaatgccaatgtg

SEQ ID NO: 8 - protein, 119 aa, Artificial Sequence
  hypB from chemically synthesized polynucleotide
MVSTFITVAKTLLVALLFVNINIVVGTATTGKHCSTGPIECCKQVMDSKSPQATELLTKNGLGLGVLAGVKGLVGANCSPITAIGIGSGSQCSGQTVCCQNNNFNGVVAIGCTPINANV

SEQ ID NO: 9 - DNA, 408 bp, Schyzophyllum commune
  CDS (1)..(408): sc3 hydrophobin, cDNA template
atgttcgcccgtctccccgtcgtgttcctctacgccttcgtcgcgttcggcgccctcgtcgctgccctcccaggtggccacccgggcacgaccacgccgccggttacgacgacggtgacggtgaccacgccgccctcgacgacgaccatcgccgccggtggcacgtgtactacggggtcgctctcttgctgcaaccaggttcaatcggcgagcagcagccctgttaccgccctcctcggcctgctcggcattgtcctcagcgacctcaacgttctcgttggcatcagctgctctcccctcactgtcatcggtgtcggaggcagcggctgttcggcgcagaccgtctgctgcgaaaacacccaattcaacgggctgatcaacatcggttgcacccccatcaacatcctc

SEQ ID NO: 10 - protein, 136 aa, Schyzophyllum commune
  sc3 hydrophobin, cDNA template
MFARLPVVFLYAFVAFGALVAALPGGHPGTTTPPVTTTVTVTTPPSTTTIAAGGTCTTGSLSCCNQVQSASSSPVTALLGLLGIVLSDLNVLVGISCSPLTVIGVGGSGCSAQTVCCENTQFNGLINIGCTPINIL

SEQ ID NO: 11 - DNA, 483 bp, Artificial Sequence
  CDS (1)..(483): BASF1 from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatg

SEQ ID NO: 12 - protein, 161 aa, Artificial Sequence
  BASF1 from chemically synthesized polynucleotide
MKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHM

SEQ ID NO: 13 - DNA, 465 bp, Artificial Sequence
  CDS (1)..(465): BASF2 from chemically synthesized polynucleotide
atgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccagcagtgcaagcagaacatcgcctgctgccagaactccccttccgacgccaccggctccctcgtcaacctcggcaacccttgcatccctgtctccctcctccatatg

SEQ ID NO: 14 - protein, 155 aa, Artificial Sequence
  BASF2 from chemically synthesized polynucleotide
MKFSVSAAVLAFAASVAALPQHDSAAGNGNGVGNKFPVPDDVTVKQATDKCGDQAQLSCCNKATYAGDVTDIDEGILAGLLKNLIGGGSGSEGLGLFDQCVKLDLQISVIGIPIQDLLNQQCKQNIACCQNSPSDATGSLVNLGNPCIPVSLLHM

SEQ ID NO: 15 - DNA, 882 bp, Bacillus subtilis
  CDS (1)..(882): yaad yaad
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctgg

SEQ ID NO: 16 - protein, 294 aa, Bacillus subtilis
  yaad yaad
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGW

SEQ ID NO: 17 - DNA, 591 bp, Bacillus subtilis
  CDS (1)..(591): yaae yaae with Gly insert at position 2
atgggattaacaataggtgtactaggacttcaaggagcagttagagagcacatccatgcgattgaagcatgcggcgcggctggtcttgtcgtaaaacgtccggagcagctgaacgaagttgacgggttgattttgccgggcggtgagagcacgacgatgcgccgtttgatcgatacgtatcaattcatggagccgcttcgtgaattcgctgctcagggcaaaccgatgtttggaacatgtgccggattaattatattagcaaaagaaattgccggttcagataatcctcatttaggtcttctgaatgtggttgtagaacgtaattcatttggccggcaggttgacagctttgaagctgatttaacaattaaaggcttggacgagccttttactggggtattcatccgtgctccgcatattttagaagctggtgaaaatgttgaagttctatcggagcataatggtcgtattgtagccgcgaaacaggggcaattccttggctgctcattccatccggagctgacagaagatcaccgagtgacgcagctgtttgttgaaatggttgaggaatataagcaaaaggcacttgta

SEQ ID NO: 18 - protein, 197 aa, Bacillus subtilis
  yaae yaae with Gly insert at position 2
MGLTIGVLGLQGAVREHIHAIEACGAAGLVVKRPEQLNEVDGLILPGGESTTMRRLIDTYQFMEPLREFAAQGKPMFGTCAGLIILAKEIAGSDNPHLGLLNVVVERNSFGRQVDSFEADLTIKGLDEPFTGVFIRAPHILEAGENVEVLSEHNGRIVAAKQGQFLGCSFHPELTEDHRVTQLFVEMVEEYKQKALV

SEQ ID NO: 19 - DNA, 1329 bp, Artificial Sequence
  CDS (1)..(1329): yaad-Xa-dewA-his fusion of Bacillus subtilis yaad and N-terminal factor Xa proteinase cleavage site and Aspergillus nidulans hydrophobin dewA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatccattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 20 - protein, 443 aa, Artificial Sequence
  yaad-Xa-dewA-his fusion of Bacillus subtilis yaad and N-terminal factor Xa proteinase cleavage site and Aspergillus nidulans hydrophobin dewA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 21 - DNA, 1395 bp, Artificial Sequence
  CDS (1)..(1395): yaad-Xa-rodA-his fusion of Bacillus subtilis yaad and N-terminal factor Xa proteinase cleavage site and Aspergillus nidulans hydrophobin rodA and his6
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccattgctgccgctgtcgttgctttcgccgcctccgtcgcggccctccctcctgcccatgattcccagttcgctggcaatggtgttggcaacaagggcaacagcaacgtcaagttccctgtccccgaaaacgtgaccgtcaagcaggcctccgacaagtgcggtgaccaggcccagctctcttgctgcaacaaggccacgtacgccggtgacaccacaaccgttgatgagggtcttctgtctggtgccctcagcggcctcatcggcgccgggtctggtgccgaaggtcttggtctcttcgatcagtgctccaagcttgatgttgctgtcctcattggcatccaagatcttgtcaaccagaagtgcaagcaaaacattgcctgctgccagaactccccctccagcgcggatggcaaccttattggtgtcggtctcccttgcgttgcccttggctccatcctcggatctcatcaccatcaccatcac

SEQ ID NO: 22 - protein, 465 aa, Artificial Sequence
  yaad-Xa-rodA-his fusion of Bacillus subtilis yaad and N-terminal factor Xa proteinase cleavage site and Aspergillus nidulans hydrophobin rodA and his6
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSIAAAVVAFAASVAALPPAHDSQFAGNGVGNKGNSNVKFPVPENVTVKQASDKCGDQAQLSCCNKATYAGDTTTVDEGLLSGALSGLIGAGSGAEGLGLFDQCSKLDVAVLIGIQDLVNQKCKQNIACCQNSPSSADGNLIGVGLPCVALGSILGSHHHHHH

SEQ ID NO: 23 - DNA, 1407 bp, Artificial Sequence
  CDS (1)..(1407): yaad-Xa-BASF1-his fusion of Bacillus subtilis yaad and N-terminal factor Xa proteinase cleavage site and artificial hydrophobin; BASF1  BASF1 from chemically synthesized polynucleotide
atggctcaaacaggtactgaacgtgtaaaacgcggaatggcagaaatgcaaaaaggcggcgtcatcatggacgtcatcaatgcggaacaagcgaaaatcgctgaagaagctggagctgtcgctgtaatggcgctagaacgtgtgccagcagatattcgcgcggctggaggagttgcccgtatggctgaccctacaatcgtggaagaagtaatgaatgcagtatctatcccggtaatggcaaaagcgcgtatcggacatattgttgaagcgcgtgtgcttgaagctatgggtgttgactatattgatgaaagtgaagttctgacgccggctgacgaagaatttcatttaaataaaaatgaatacacagttccttttgtctgtggctgccgtgatcttggtgaagcaacacgccgtattgcggaaggtgcttctatgcttcgcacaaaaggtgagcctggaacaggtaatattgttgaggctgttcgccatatgcgtaaagttaacgctcaagtgcgcaaagtagttgcgatgagtgaggatgagctaatgacagaagcgaaaaacctaggtgctccttacgagcttcttcttcaaattaaaaaagacggcaagcttcctgtcgttaactttgccgctggcggcgtagcaactccagctgatgctgctctcatgatgcagcttggtgctgacggagtatttgttggttctggtatttttaaatcagacaaccctgctaaatttgcgaaagcaattgtggaagcaacaactcactttactgattacaaattaatcgctgagttgtcaaaagagcttggtactgcaatgaaagggattgaaatctcaaacttacttccagaacagcgtatgcaagaacgcggctggagatctattgaaggccgcatgaagttctccgtctccgccgccgtcctcgccttcgccgcctccgtcgccgccctccctcagcacgactccgccgccggcaacggcaacggcgtcggcaacaagttccctgtccctgacgacgtcaccgtcaagcaggccaccgacaagtgcggcgaccaggcccagctctcctgctgcaacaaggccacctacgccggcgacgtcctcaccgacatcgacgagggcatcctcgccggcctcctcaagaacctcatcggcggcggctccggctccgagggcctcggcctcttcgaccagtgcgtcaagctcgacctccagatctccgtcatcggcatccctatccaggacctcctcaaccaggtcaacaagcagtgcaagcagaacatcgcctgctgccagaactccccttccgacgccaccggctccctcgtcaacctcggcctcggcaacccttgcatccctgtctccctcctccatatgggatctcatcaccatcaccatcac

SEQ ID NO: 24 - protein, 469 aa, Artificial Sequence
  yaad-Xa-BASF1-his fusion of Bacillus subtilis yaad and N-terminal factor Xa proteinase cleavage site and artificial hydrophobin BASF1; BASF1 from chemically synthesized polynucleotide
MAQTGTERVKRGMAEMQKGGVIMDVINAEQAKIAEEAGAVAVMALERVPADIRAAGGVARMADPTIVEEVMNAVSIPVMAKARIGHIVEARVLEAMGVDYIDESEVLTPADEEFHLNKNEYTVPFVCGCRDLGEATRRIAEGASMLRTKGEPGTGNIVEAVRHMRKVNAQVRKVVAMSEDELMTEAKNLGAPYELLLQIKKDGKLPVVNFAAGGVATPADAALMMQLGADGVFVGSGIFKSDNPAKFAKAIVEATTHFTDYKLIAELSKELGTAMKGIEISNLLPEQRMQERGWRSIEGRMKFSVSAAVLAFAASVAALPQHDSAAGNGNGVGNKFPVPDDVTVKQATDKCGDQAQLSCCNKATYAGDVLTDIDEGILAGLLKNLIGGGSGSEGLGLFDQCVKLDLQISVIGIPIQDLLNQVNKQCKQNIACCQNSPSDATGSLVNLGLGNPCIPVSLLHMGSHHHHHH

SEQ ID NO: 25 - DNA, 561 bp, Artificial sequence
  CDS (1)..(561): DNA sequence encoding fusion protein yaad40- Xa-dewA-his
atggctcaaacaggtactgaacgtgtaaaacgcggaatggcagaaatgcaaaaaggcggcgtcatcatggacgtcatcaatgcggaacaagcgaaaatcgctgaagaagctggagctgtcattgaaggccgcatgcgcttcatcgtctctctcctcgccttcactgccgcggccaccgcgaccgccctcccggcctctgccgcaaagaacgcgaagctggccacctcggcggccttcgccaagcaggctgaaggcaccacctgcaatgtcggctcgatcgcttgctgcaactcccccgctgagaccaacaacgacagtctgttgagcggtctgctcggtgctggccttctcaacgggctctcgggcaacactggcagcgcctgcgccaaggcgagcttgattgaccagctgggtctgctcgctctcgtcgaccacactgaggaaggccccgtctgcaagaacatcgtcgcttgctgccctgagggaaccaccaactgtgttgccgtcgacaacgctggcgctggtaccaaggctgagggatctcatcaccatcaccatcac

SEQ ID NO: 26 - protein, 187 aa, artificial sequence
  fusion protein yaad40-Xa-dewA-his
MAQTGTERVKRGMAEMQKGGVIMDVINAEQAKIAEEAGAVIEGRMRFIVSLLAFTAAATATALPASAAKNAKLATSAAFAKQAEGTTCNVGSIACCNSPAETNNDSLLSGLLGAGLLNGLSGNTGSACAKASLIDQLGLLALVDHTEEGPVCKNIVACCPEGTTNCVAVDNAGAGTKAEGSHHHHHH

SEQ ID NO: 27 - protein, 19 aa, artificial sequence
  P18cys corresponding to P18 with added C- terminal cysteine
KWKLFKKIPKFLHLAKKFC